(19) United States
(12) Patent Application Publication
(10) Pub. No.: US 2026/0160610 A1
(43) Pub. Date: Jun. 11, 2026

(54) ACTIVATABLE THERMAL INDICATOR WITH BLISTERS

(71) Applicant: Zebra Technologies Corporation, Lincolnshire, IL (US)

(72) Inventors: Eric W. LIBERATO, Pequannock, NJ (US); Brian S. HUFFMAN, Belle Mead, NJ (US); Mohannad ABDO, Clifton, NJ (US)

(73) Assignee: Zebra Technologies Corporation, Lincolnshire, IL (US)

(21) Appl. No.: 18/969,777

(22) Filed: Dec. 5, 2024

(51) Int. Cl. G01K 11/00

(52) U.S. Cl. CPC G01K 11/00

(57) ABSTRACT

Activatable thermal indicators with blisters are disclosed herein. An example activatable environmental exposure indicator with a blister, includes a substrate; an indicator region; a reservoir in fluid communication with the indicator region; a blister covering the reservoir and having an internal surface; and a plurality of microcapsules, contained in the reservoir and covered by the blister; wherein applying a compressive force exceeding a predetermined threshold to the blister causes the blister to deform so the internal surface of the blister contacts the plurality of microcapsules, so that the activation action is applied to the plurality of microcapsules.

### BACKGROUND

Environmental indicators may be configured to indicate the occurrence of an environmental exposure to a host product. Prior to the association between the host product and the indicator, the same level of care must often be paid to the indicator to prevent an exposure to the environmental condition which the indicator is configured to indicate, so that the indicator is not triggered prematurely and rendered unusable for use with the host product. For example, high temperature exposure indicators may need to be kept in deep freeze or refrigerated conditions, complicating the component supply chains for the products they are used with. Activatable environmental indicators have been previously proposed.

### SUMMARY

In a first embodiment, the technology of the present disclosure may be provided by an activatable environmental exposure indicator, including a substrate; an indicator region; a reservoir in fluid communication with the indicator region; a blister covering the reservoir and having an internal surface; and a plurality of microcapsules, contained in the reservoir and covered by the blister. Each microcapsule of the plurality of microcapsules includes a payload microencapsulated in a frangible shell. The payload includes a liquefiable material configured to liquefy responsive to a predetermined environmental exposure. The frangible shells are configured to rupture responsive to an activation action, releasing the payload from the frangible shells. After being released from the frangible shells, and responsive to the predetermined environmental exposure causing liquefication of the liquefiable material, the payload is configured to migrate into the indicator region producing an observable effect in the indicator region. The frangible shells are configured to block the payload from migrating to the indicator region prior to the activation action. Applying a compressive force exceeding a predetermined threshold to the blister causes the blister to deform so the internal surface of the blister contacts the plurality of microcapsules, so that the activation action is applied to the plurality of microcapsules.

In an example aspect of the first embodiment, the internal surface of the blister includes a rough material, configured to facilitate rupturing the frangible shells when the blister applies the activation action to the plurality of microcapsules.

In an example aspect of the first embodiment, a surface of the reservoir opposite the internal surface of the blister includes a rough material, configured to facilitate rupturing the frangible shells when the blister applies the activation action to the plurality of microcapsules.

In an example aspect of the first embodiment, the reservoir is housed within the indicator region, and the blister includes a transparent material wherein the observable effect is viewable through the blister when the payload produces the observable effect in the indicator region.

In an example aspect of the first embodiment, the blister is integrated with a cover layer which overlays the activatable environmental exposure indicator.

In an embodiment aspect of the first embodiment, the cover layer further includes at least a viewing window through which the indicator region is viewable.

In an example aspect of the first embodiment, the cover layer is a vacuum molded transparent layer.

In an embodiment aspect of the first embodiment, the blister is integrated with the substrate.

In an example aspect of the first embodiment, the blister includes a material selected from the group consisting of polyvinyl chloride (PVC), polyethylene terephthalate (PET), polypropylene, polychlorotrifluoroethylene (PCTFE), linear low-density polyethylene (LLDPE), polyvinylidene chloride (PVDC), cyclic olefin copolymer (COP), and combinations thereof.

In an example aspect of the first embodiment, the indicator region is selected from a group consisting of a destination wick which is configured to be saturated by the payload when liquefiable material is liquefied, and a destination reservoir into which the payload is configured to flow when the liquefiable material is liquefied.

In an example aspect of the first embodiment, the activatable environmental exposure indicator further includes a migration component, connectively disposed between the indicator region and the reservoir, wherein the payload migrates through the migration component when the liquefiable material is liquefied and after the activation action.

In an example aspect of the first embodiment, the predetermined environmental exposure is an exposure to an environmental condition above a predetermined threshold, and liquefiable material is configured to liquefy responsive to the environmental condition exceeding the predetermined threshold and solidify responsive to the environmental condition receding below the predetermined threshold. After of the activation action, the payload migrates through the migration component while the environmental condition exceeds the predetermined threshold, and halts migration when the environmental condition recedes below the predetermined threshold and until the environmental condition subsequently exceeds the predetermined threshold.

In an example aspect of the first embodiment, the activatable environmental exposure indicator is a time-temperature indicator, configured such that the environmental condition is an ambient temperature, and the predetermined threshold is a temperature threshold. After the payload is released from the frangible shells, responsive to the activatable environmental exposure indicator being exposed to a temperature above the predetermined threshold the payload migrates along the migration component, and the liquefiable material resolidifies at a temperature below the predetermined threshold, halting migration of the payload along the migration component.

In an example aspect of the first embodiment, the activatable environmental exposure indicator further includes a plurality of indicator regions, each of the plurality of indicator regions disposed at a respective predetermined location along the migration component, wherein after the activation action, the payload is configured to reach each predetermined location after a respective amount of time for which the environmental condition exceeds the predetermined threshold, and produce the observable effect in corresponding respective indicator region.

In an example aspect of the first embodiment, the migration component is selected from a group consisting of a wick, a plurality of capillary tubes, a plurality of microchannels.

In an example aspect of the first embodiment, the observable effect is a change in an apparent color state of at least a portion of the indicator region resulting from the payload reaching the portion of the indicator region and the payload includes an indicator material configured to change the apparent color state of the portion of the indicator region, the indicator material having a component selected from a group consisting of: a dye, a colorant, an ink, a first reactant configured to react with a second reactant disposed in the indicator region to produce a color state change, a reflective material, a flash material configured to give a bright appearance when illuminated with light of a predetermined wavelength, and combinations thereof.

In an example aspect of the first embodiment, the observable effect is a change in an electrical property of the indicator region as detected by a circuit connected to the indicator region, wherein the electrical property is selected from a group consisting of conductivity, resistivity, impedance, capacitance, and inductance.

In an example aspect of the first embodiment, the payload includes a plurality of conductive particles configured to change the electrical property of the indicator region, the plurality of conductive particles selected from a group consisting of particles containing copper, particles containing silver, particles containing graphite, particles containing graphene, particles containing graphene oxide, particles containing other functionalized graphenes, particles containing conductive metals, particles containing conductive non-metal materials, electroconductive carbon black, and combinations thereof.

In an example aspect of the first embodiment, the activation action includes a compression force applied to the blister above a predetermined activation pressure threshold selected from a group consisting of: a compression stress exceeding 0.1 pounds per square inch (psi), a compression stress exceeding 0.5 psi, a compression stress exceeding 1 psi, a compression stress exceeding 2 psi, a compression stress exceeding 5 psi, a compression stress exceeding 10 psi, and a compression stress exceeding 15 psi.

In an example aspect of the first embodiment, the predetermined environmental exposure is selected from a group consisting of: a temperature excursion above a predetermined temperature threshold for at least a predetermined amount of time, temperature excursion below a predetermined temperature for at least a predetermined amount of time, cumulative exposure to temperature for at least a predetermined amount of time above a predetermined threshold, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, a predetermined electromagnetic exposure, a humidity exposure, an exposure to a humidity level above a predetermined threshold, and an exposure to a humidity level above a predetermined threshold for at least a predetermined amount of time.

In a second embodiment, the technology of the present disclosure may be provided by a method of fabricating an activatable environmental exposure indicator, including providing a cover layer; forming a blister in the cover layer; depositing a plurality of microcapsules into the blister, each microcapsule of the plurality of microcapsules containing a payload microencapsulated in a frangible shell, the frangible shells configured to rupture responsive to an activation action and release the payload, the payload including a liquefiable material configured to liquefy responsive to a predetermined environmental exposure, the liquefiable material being retained by the frangible shells prior to rupture, and free to flow when liquefied after rupture of the frangible shells by the activation action; overlaying a wick onto the cover layer, the wick including an activation portion, a migration portion and an indicator portion, the wick adjacent to or in contact with the blister; overlaying a substrate onto the wick, microcapsules, and cover layer; and sealing the wick and the plurality of microcapsules between the cover layer and the substrate.

In an example aspect of the second embodiment, the method further includes applying a rough material to the cover layer at a location of the blister.

In a third embodiment, the technology of the present disclosure may be provided by an article of manufacture including a web of environmental exposure indicators, each indicator in the web of indicators demarcated by lines of weakness, each indicator in the web of substrates including: a substrate; an indicator region; a reservoir in fluid communication with the indicator region; a blister covering the reservoir and having an internal surface; and a plurality of microcapsules, contained in the reservoir and covered by the blister. Each microcapsule of the plurality of microcapsules includes a payload microencapsulated in a frangible shell. The payload includes a liquefiable material configured to liquefy responsive to a predetermined environmental exposure. The frangible shells are configured to rupture responsive to an activation action, releasing the payload from the frangible shells. After being released from the frangible shells, and responsive to the predetermined environmental exposure causing liquefication of the liquefiable material, the payload is configured to migrate into the indicator region producing an observable effect in the indicator region. The frangible shells are configured to block the payload from migrating to the indicator region prior to the activation action. Applying a compressive force exceeding a predetermined threshold to the blister causes the blister to deform so the internal surface of the blister contacts the plurality of microcapsules, so that the activation action is applied to the plurality of microcapsules.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed technology and explain various principles and advantages of those embodiments.

FIG. 1 illustrates a microcapsule, according to embodiments of the present disclosure.

FIGS. 2A-2C illustrate views of a first embodiment of an activatable environmental exposure indicator, according to embodiments of the present disclosure.

FIG. 3 illustrates a second embodiment of an activatable environmental exposure indicator, according to embodiments of the present disclosure.

FIG. 4 illustrates a detailed view of a blister with a roughened internal surface, according to embodiments of the present disclosure.

FIG. 5 illustrates a web of activatable environmental exposure indicators, according to embodiments of the present disclosure.

FIG. 6 illustrates method of forming activatable environmental exposure indicators, according to embodiments of the present disclosure.

Skilled artisans will appreciate that elements in the figures are illustrated for simplicity and clarity and have not necessarily been drawn to scale. For embodiment, the dimensions of some of the elements in the figures may be exaggerated relative to other elements to help to improve understanding of embodiments of the present technology.

The apparatus and method components have been represented where appropriate by conventional symbols in the drawings, showing only those specific details that are pertinent to understanding the embodiments of the present technology so as not to obscure the disclosure with details that will be readily apparent to those of ordinary skill in the art having the benefit of the description herein.

### DETAILED DESCRIPTION

The technology of the present disclosure is related to an activation platform for environmental indicators, such as peak temperature exposure and time-temperature indicators. Environmental indicators (e.g., indicators incorporating an indicator material that liquefies in response to a predetermined environmental exposure) may be configured to indicate the occurrence of such a predetermined environmental exposure to a host product, e.g., by changing appearance of an indicator region. Prior to the association between the host product and the indicator, the same level of care must be paid to the indicator to prevent an exposure to the environmental condition of which the indicator is configured to indicate, such that the indicator is not spent prematurely and rendered unusable with the host product. Said differently, if a thermal indicator is to be installed on a host product, the indicator may need to be held below the temperature at which the thermal indicator is configured to indicate prior to installation of the indicator on or with a monitored host product. If a sufficient thermal exposure were to occur prior to pairing with the host product, the indicator would transition to an indicative state prior to installation, and, provided the indicator is an irreversible indicator, the indicator would be expended prior to use. For embodiment, indicators configured for use with refrigerated items, e.g., indicators showing when host products have warmed above a refrigerator temperature, the indicators generally need to be refrigerated prior to being paired with a host product, which results in an additional cost and more complicated inventory management and manufacturing process for the user. Using an indicator that requires an application of an activation action before becoming sensitive to environmental exposure may help avoid these problems. Various types of activable indicators have been previously proposed.

The activatable environmental exposure indicators of the present disclosure employ microcapsules having a frangible shell containing a payload. The microcapsules are activatable by application of an activation action, such as an external application of a compressive or shear force sufficient to rupture the frangible shells of the microcapsules to facilitate release of the payload. In some embodiments, the application of heat may be provided to weaken the frangible shells and lower a pressure threshold of the activation action.

In some embodiments of the present disclosure, the payload contained within the microcapsules is environmentally sensitive, or contains environmentally sensitive materials, which exhibit a phase change responsive to a predetermined environmental exposure. The indicators may be configured, along with, in some embodiments, other materials contained in the payload, to produce or display an observable effect in an indicator region responsive to the phase change resulting from the predetermined environmental exposure. The microcapsules are generally configured to prevent this production or display of the observable effect, regardless of exposures to the predetermined environmental exposure, until the microcapsules are ruptured, and the payload is released. In this manner, the indicators are activatable, as the rupturing of the microcapsules may be controlled by a user, such that the indicator does not become environmentally sensitive until the activation action which ruptures the microcapsules is applied.

When an activatable environmental exposure indicator is activated, e.g., by applying a compressive force to an activation region of the indicators, the microcapsules are subject to the activation action, ideally resulting in the rupturing of the microcapsules. In practice, there generally exists a portion of the microcapsules which, for one reason or another, may not be ruptured. Some reasons for inconsistent rupturing may include inconsistent application of the activation action, inconsistencies in the formation of the microcapsules, and other environmental factors. As a result, a less-than-ideal quantity of payload may be released from the microcapsules and subsequently be involved in the production of the observable effect in the indicator region. The quantity of microcapsules needed to achieve the observable effect after activation and environmental exposure may need to be increased to compensate for imperfect activation, or for other conditions which reduce the effectiveness of the payload in producing the observable effect.

In a mode of increasing the amount of payload released from the microcapsules responsive to the activation action, the microcapsules are housed in a blister having a rough or abrasive internal surface configured to aid in the rupturing of the microcapsules when the activation action is applied. The rough or abrasive internal surface of the blister may abrade, puncture, or shear the frangible shells of the microcapsules as the activation action applied. Additionally, the blister may be configured to increase the quantity of microcapsules which may be stored by the activatable environmental exposure indicator, so that a sufficient quantity of payload is released even when activation is less than complete.

The discussion contained in the following detailed description has been organized as follows:
Section I: Some Relevant Materials and Notable Properties Thereof.
Section II: Rupturable Microcapsules
Section III: Embodiments of Activatable Environmental Exposure Indicators.

### Section I: Some Relevant Materials and Notable Properties Thereof

### Liquefiable Materials

Various embodiments of activatable environmental exposure indicators discussed herein utilize a liquefiable material that can be configured to react to an environmental exposure temperature above a predetermined threshold relatively quickly. This is because the liquefiable material of some embodiments is configured or selected to have a sharp melting point, such that liquefaction happens very quickly over a small temperature range. Thus, exposure to a predetermined environmental exposure, e.g., a peak temperature exceeding the melting point of the liquefiable material, causes a quick state change. However, notwithstanding a relatively quick response by the liquefiable material to heat, some indicators discussed herein exhibit a time-dependent response that halts when conditions return below the environmental exposure temperature threshold and resumes again in an additive manner. Again, in some embodiments, this is due to the liquefiable material having a sharp transition between a liquid phase and a solid phase.

For embodiment, where an indicator is configured to signal a response after an exposure of about 30 minutes at and/or above the environmental exposure temperature threshold, a 20-minute exposure will not trigger an observable response in the indicator region, but if the indicator is again exposed to a temperature at and/or above the environmental exposure temperature threshold, a reduced amount of exposure, e.g. about 10 more minutes of exposure may yield a response. In some embodiments as noted above, this behavior is achieved because the liquefiable solid (such as a side-chain crystalline polymer) readily liquefies and solidifies within a narrow temperature range. Once the environmental exposure temperature has been exceeded, a drop in temperature below the environmental exposure will cause almost immediate cessation of the time-dependent response with such materials. The response will resume once the environmental exposure temperature threshold is again exceeded.

As used herein, the terms “predetermined environmental exposure” and “environmental exposure temperature threshold” have an understood meaning in the art and include a temperature, usually a temperature above 0° C. (though temperatures below 0° C. are also contemplated), that can cause damage or harm to a product, such as a food or a vaccine that may require refrigeration to avoid spoilage or maintain efficacy for extended periods. The term “environmental exposure temperature threshold,” then, can include any predetermined temperature that is above a desired storage temperature of a perishable product, though in some cases exposure for short periods of time may not damage or harm a particular product. Thus, some embodiments disclosed herein can be configured to provide signal of exposure to temperatures at and/or above an environmental exposure temperature threshold only after a specified amount of time even if exposure occurs at different times.

In some embodiments, the liquefiable material has a “sharp” liquefaction point, meaning that the transition from solid to liquid happens very quickly over a very small temperature range. In some embodiments, liquefaction temperature and solidification temperature of the liquefiable solid are identical. In some embodiments, the liquefaction and solidification temperatures are within about 0.1° C., within about 0.5° C., within about 1.0° C., within about 1.5° C., within about 2° C., within about 2.5° C., within about 3.0° C., within about 3.5° C., within about 4.0° C., within about 4.5° C., within about 5° C., or within about 10° C. of each other.

As used herein, the term “solid phase” may refer to a material in a non-liquid state such that the material is incapable of fluid flow. In some embodiments “solid phase” may refer to a gelled state, a highly viscous state, a true solid state, and the like. Similarly, the terms “solidification” and “solidify” are used to describe the transition in which a material not in the solid phase enters the solid phase. The terms “solidification point” and “solidification temperature” are used to describe a temperature, or temperature range, at or in which a material may undergo solidification.

As used herein, the term “liquid phase” is used to describe a state of a material in which the material is capable of fluid flow. Similarly, the terms “liquefaction” and “liquefy” are used to describe the transition in which a material not in the liquid phase enters the liquid phase. The terms “liquefaction point” and “liquefaction temperature” are used to describe a temperature, or temperature range, at or in which a material may undergo liquefaction.

Suitable liquefiable materials include synthetic polymeric materials that are solid below the threshold temperature and are, or can become, a flowing amorphous solid or a viscous liquid when at and/or above a threshold temperature. Such synthetic polymeric materials are liquefiable, as defined herein. Useful synthetic polymers can also be hydrophobic, if desired. Suitable liquefiable materials include side-chain crystallizable polymers (e.g., various methacrylates, such as poly(hexadecylmethacrylate); a polymer or a copolymer having at least one crystallizable side chain selected from the group consisting of a C4-30 aliphatic group; a C6-30 aromatic group; a linear aliphatic group having at least 10 carbon atoms; a combination of at least one aliphatic group and at least one aromatic group, the combination having from 7 carbon atoms to about 30 carbon atoms; a C10-C22 acrylate; a C10-C22 methacrylate; an acrylamide; a methacrylamide; a vinyl ether; a vinyl ester; a fluorinated aliphatic group having at least 6 carbon atoms; and a p-alkyl styrene group wherein the alkyl group has from about 8 carbon atoms to about 24 carbon atoms.).

As used herein, the term “polymer”, and its linguistic variations, refers to copolymers, and higher order polymers, as well as homopolymers, unless the context indicates otherwise, for embodiment, by describing or referencing one or more specific homopolymers.

When solid, the synthetic polymeric material can be crystalline or partially crystalline. Crystalline or partially crystalline synthetic polymeric materials can have desirably sharp transitions from a solid state to a liquid state.

Side chain (liquid) crystalline polymers (abbreviated as SCC hereafter) are particularly suitable liquefiable materials, though other suitable materials such as waxes could readily be used. SCC polymers have a conventional polymer backbone and side chains that can co crystallize. Typically, they are chains that have six or more carbons with a crystallization temperature that is, therefore, adjustable. In some embodiments, the side chains “melt” independently of the main polymer chain so that the phenomenon can be used to release other materials that have been encapsulated within the overall polymer structure. Another advantage of SCC polymers is that their molecular weight and degree of crosslinking can be adjusted to control their physical properties including their permeability and in turn provide an approach to tailor the time delay.

Some embodiments of SCC polymers include poly(dodecylacrylate), poly(tetradecylacrylate), poly(hexadecylacrylate), poly(octadecylacrylate), copolymer of hexylacrylate and dodecylacrylate, copolymer of hexylacrylate and docosylacrylate, copolymer of decylacrylate and tetradecylacrylate, copolymer of decylacrylate and octadecylacrylate, copolymer of decylacrylate and octadecylacrylate, copolymer of decylacrylate and octadecylacrylate, copolymer of dodecylacrylate and docosylacrylate, copolymer of dodecylacrylate and docosylacrylate, copolymer of dodecylacrylate and docosylacrylate, copolymer of tetradecylacrylate and octadecylacrylate, copolymer of tetradecylacrylate and octadecylacrylate, copolymer of tetradecylacrylate and octadecylacrylate, poly(dodecylmethacrylate), poly(tetradecylmethacrylate), poly(hexadecylmethacrylate), poly(octadecylmethacrylate), copolymer of tetradecylmethacrylate and methyl methacrylate, copolymer of octadecylmethacrylate and methyl methacrylate.

For embodiment, the liquefiable material may be a side-chain crystallizable polymer combined with an alkane wax. Some side-chain crystallizable (SCC) polymers useful in the practice of the present disclosure, alone or in combination, and methods that can be employed for preparing them, are described in O'Leary et al. “Copolymers of poly(n-alkyl acrylates): synthesis, characterization, and monomer reactivity ratios” in Polymer 2004 45 pp 6575-6585 (“O'Leary et al.” herein), and in Greenberg et al. “Side Chain Crystallization of n-Alkyl Polymethacrylates and Polyacrylates” J. Am. Chem. Soc., 1954, 76 (24), pp. 6280-6285 (“Greenberg et al.” herein). The disclosure of each of O'Leary et al. and Greenberg et al. is incorporated by reference herein for all purposes.

Side-chain crystallizable polymers, sometimes called “comb-like” polymers, are well-known and available commercially. These polymers are reviewed in J. Polymer Sci. Macromol. Rev. 8:117-253 (1974), the disclosure of which is hereby incorporated by reference. In general, these polymers contain monomer units X of the formula:

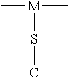

where M is a backbone atom, S is a spacer unit and C is a crystallizable group. These polymers have a heat of fusion (ΔH_{f}) of at least about 20 Joules/g, preferably at least about 40 Joules/g. The polymers will contain about 50 to 100 percent monomer units represented by “X”. If the polymer contains less than 100 percent X, in addition contain monomer units which may be represented by “Y” or “Z”, or both, wherein Y is any polar or nonpolar monomer or mixture of polar or nonpolar monomers capable of polymerizing with X and/or Z, and wherein Z is a polar monomer or mixture of polar monomers. Polar groups, e.g., polyoxyalkylenes, acrylates including hydroxyethylacrylate, acrylamides including methacrylamide—will typically increase adhesion to most substrates. If the polar species “Z” is acrylic acid, it is preferred that it comprise about 1-10 wt. percent of the polymer.

The backbone of the polymer (defined by “M”) may be any organic structure (aliphatic or aromatic hydrocarbon, ester, ether, amide, etc.) or an inorganic structure (sulfide, phosphazine, silicone, etc.), and may include spacer linkages which can be any suitable organic or inorganic unit, for embodiment ester, amide, hydrocar bon, phenyl, ether, or ionic salt (e.g., a carboxyl-alkyl ammonium or sulphonium or phosphonium ion pair or other known ionic salt pair).

The side-chain (defined by ‘S’ and ‘C’) may be aliphatic or aromatic or a combination of aliphatic and aromatic, but must be capable of entering into a crystal line state. Common embodiments are: linear aliphatic side chains of at least 10 carbon atoms, e.g., C₄-C₂₂ acrylates or methacrylates, acrylamides or methacrylamides, vinyl ethers or esters, siloxanes or alpha olefins; fluorinated aliphatic side-chains of at least 6 carbons; and p-alkyl styrene side-chains wherein the alkyl is of 8 to 24 carbon atoms.

The length of the side-chain moiety is usually greater than 5 times the distance between side-chains in the case of acrylates, methacrylates, vinyl esters, acrylamides, methacrylamides, vinyl ethers and alpha olefins. In the extreme case of a fluoroacrylate alternate copolymer with butadiene, the side-chain can be as little as two times the length as the distance between the branches.

In any case, the side-chain units should make up greater than 50 percent of the volume of the polymer, preferably greater than 65 percent of the volume. Specific embodiments of side-chain crystallizable monomers are the acrylate, fluoroacrylate, methacrylate and vinyl ester polymers described in J. Poly. Sci 10:3347 (1972); J. Poly. Sci 10:1657 (1972); J. Poly. Sci 9:3367 (1971); J. Poly. Sci 9:3349 (1971); J. Poly. Sci. 9:1835 (1971); J.A.C.S. 76:6280 (1954); J. Poly, Sci 7:3053 (1969); Polymer J. 17:991 (1985), corresponding acryl amides, substituted acrylamide and maleimide polymers (J. Poly. Sci: Poly. Physics Ed. 18:2197 (1980)); polyalphaolefin polymers such as those described in J. Poly. 5,156,911 7 Sci. Macromol. Rey, 8:117-253 (1974) and Macromolecules 13:12 (1980), polyalkylvinylethers, polyalkylethylene oxides such as those described in Macromolecules 13:15 (1980), alkylphosphazene polymers, polyamino acids such as those described in Poly. Sci. USSR 21:241, Macromolecules 18:2141, polyisocyanates such as those described in Macromolecules 12:94 (1979), polyurethanes made by reacting amine-or alcohol-containing monomers with long-chain alkyl isocyanates, polyesters and polyethers, polysiloxanes and polysilanes such as those described in Macromolecules 19:611 (1986), and p-alkylstyrene polymers such as those described in J.A.C.S. 75:3326 (1953) and J. Poly. Sci 60:19 (1962). Of specific utility are polymers which are both relatively polar and capable of crystallization, but wherein the crystallizing portion is not affected by moisture. For embodiment, incorporation of polyoxyethylene, polyoxypropylene, polyoxybutylene or copolyoxyalkylene units in the polymer will make the polymer more polar.

In a particularly preferred embodiment herein, in the above structure, —C is selected from the group consisting of —(CH₂)—CH₃ and —(CF₂)ₙ—CF₂H, where n is an integer in the range of 8 to 20 inclusive, —S— is selected from the group consisting of —O—, —CH₂—, —(CO)—, —O(CO)— and —NR— where R is hydrogen or lower alkyl (1-6C), and -M- is —[(CH₂)ₘ—CH]— where m is 0 to 2.

Typical “Y” units include linear or branched alkyl or aryl acrylates or methacrylates, alpha olefins, linear or branched alkyl vinyl ether or vinyl esters, maleicesters or itaconic acid esters, acrylamides, styrenes or substituted styrenes, acrylic acid, methacrylic acid and hydrophilic monomers as detailed in WO84/0387, cited supra.

Some useful side-chain crystallizable polymers, and monomers for preparing side-chain crystallizable polymers, are also available from commercial suppliers, for embodiment, Scientific Polymer Products, Inc., Ontario, N.Y., Sigma-Aldrich, Saint Louis, Mo., TCI America, Portland Oreg., Monomer-Polymer & Dajac Labs, Inc., Trevose, Pa., San Esters Corp., New York, N.Y., Sartomer USA, LLC, Exton Pa., and Polysciences, Inc.

Other suitable liquefiable materials may be alkane waxes alone, without SCCs, or alkane waxes blended with SCCs. It will be appreciated that other materials may also be included in the payload, such as conditioners, thinning or thickening agents, colorants, and other materials.

### Frangible Shells

Various embodiments of activatable environmental exposure indicators and activation indicator components discussed herein utilize microcapsules having frangible shells, which are employed to microencapsulate several other materials (e.g., liquefiable materials, indicator materials, thermally expansive materials, thermally expandable microspheres) forming a microcapsule. The frangible shells are rupturable, e.g., the frangible shells rupture and release the payload when subjected to an activation action.

The microcapsules may be any size, but in one such embodiment, has an outer diameter length between 20-1000 μm. The frangible shell may be any size smaller than or equal to the outer diameter of the microcapsule. The microcapsules can have a thickness between 1 to 25 micrometers (μm). The payload ratio, or the ratio of the total weight of the payload within the microcapsule to the entire weight of the microcapsule including the contents contained within the microcapsule, can range from 50 percent to 90 percent. A variety of microcapsule frangible shell materials may be chosen, depending on the application, the mode of rupture, and the nature of the contents of the microcapsule. In general, the microcapsules should resist the passage, whether by flow, diffusion, or migration, of the contents of the microcapsule prior to rupturing.

For embodiment, the frangible shell may be formed in whole or in part by a wax, e.g., an alkane wax, or other acid resistant compound having a relatively high melting point, e.g., fatty acid amide, an ester or Elvax EVA resin. For embodiment, the melting point may be in a range of about 50 degrees Celsius (C.) to about 300 degrees C., from about 100 degrees C. to about 300 degrees C., from about 150 degrees C. to about 300 degrees C., from about 200 degrees C. to about 300 degrees C., from about 250 degrees C. to about 300 degrees C. Generally, the shell should have a higher melting point than the maximum temperature the microcapsule is expected to be exposed to in normal use, to prevent it from rupturing or melting prematurely.

In another embodiment, the frangible shell may be formed in whole or in part by a polymer coating having a high glass transition temperature (T_{g}) e.g. Polysulfone. For embodiment, the glass transition temperature may be in a range of about 50 degrees C. to about 300 degrees C., from about 100 degrees C. to about 300 degrees C., from about 150 degrees C. to about 300 degrees C., from about 200 degrees C. to about 300 degrees C., from about 250 degrees C. to about 300 degrees C. For embodiment, Polysulfone, with a T_{g} of about 190 C may be used. In additional embodiments, the microcapsules 100 may be one of Styrene Maleic Anhydride (SMA), Polyphenylene Ether (PPE), Cellulose Acetate, Cellulose Diacetate, Polyacrylate, Polyamide, Polycarbonate, polyether ether ketone, Polyether Sulfone, PET, PFA, polymethyl methacrylate (PMMA) or Polyimide.

In another embodiment, the frangible shell may be formed in whole or in part by a low molecular weight polymer gel having a high melting point, e.g., fatty acid amide, an ester or Elvax EVA resin. For embodiment, the melting point may be in a range of about 100 degrees C. to about 300 degrees C., from about 150 degrees C. to about 300 degrees C., from about 200 degrees C. to about 300 degrees C., from about 250 degrees C. to about 300 degrees C. Additionally, in some embodiments, the polymer gel has a molecular weight in a range from about 1 grams per mole (g/mol) to 100,000 g/mol, from about 3,500 g/mol to 6,000 g/mol and from about 200 g/mol to 2,000 g/mol.

Alternatively, the frangible shell may be formed in whole or in part by a gel, gelatin, protein, polyurea formaldehyde, polymelamine formaldehyde, wax material, melamine, or an emulsion. The microcapsules may be available in wet and dry formulations. Polymelamine and polyurea formaldehyde can both be used for encapsulations via interfacial polymerization, which uses two immiscible phases. Once separated in the same vessel, a reaction is initiated at the interface of the two immiscible phases in the presence of an initiator and the material to be encapsulated. As polymerization occurs, microcapsules form around the core material. The microcapsule releases the contents of the microcapsule upon rupturing.

The microcapsule is initially in an unruptured form, capable of being configured to transition to a ruptured form through exposure to an activation action, e.g., the application of heat, pressure, and/or a combination of heat and pressure exceeding a predetermined threshold. In the unruptured form, the frangible shell of the microcapsule maintains separation between the contents of the microcapsule and any external environmental stimuli and/or contains a phase change of the contents of the microcapsule in response to any external environmental stimuli.

The frangible shells may be “ruptured” (e.g., broken, disengaged, dissolved, etc.) by applying an activation action to the microcapsule. In some embodiments “applying an activation action” may constitute exposing the microcapsule to an activation action, such as a pressure stress or a thermal stress, or a combination thereof. The activation action may directly or indirectly cause the frangible shell to fracture, melt, break, dissolve, sublime, become porous, or otherwise disengage, allowing the release of the contents of the frangible shell. In some embodiments, the frangible shells may be ruptured by one or more activation actions. In some such embodiments, simultaneous activation actions may be applied to rupture the microcapsules. In other such embodiments, ordered or non-ordered sequential activation actions may be applied to rupture the microcapsules.

One rupture mode is rupture or weaking by means of externally applied pressure. In some embodiments, the microcapsules may be ruptured by a source of external pressure, where the activation action is an exposure to a compressive or shearing force. The frangible shells may be configured such that the predetermined activation threshold corresponds to a compression stress or a shear stress of sufficient magnitude to rupture the frangible shell. In some embodiments, the predetermined stress threshold is a compressive stress or a shearing stress exceeding about 0.1 pounds per square inch (psi), a compressive stress or a shearing stress exceeding about 0.5 psi, a compressive stress or a shearing stress exceeding about 1 psi, a compressive stress or a shearing stress exceeding about 2 psi, a compressive stress or a shearing stress exceeding about 5 psi, a compressive stress or a shearing stress exceeding about 10 psi, or a compressive stress or a shearing stress exceeding about 15 psi. The activation stress ranges given are purely exemplary and the microcapsules can be formed to respond to other stress ranges.

The activation pressure ranges given are purely exemplary and other ranges may be sufficient to rupture or weaken the frangible shells, where such pressure ranges may vary based on a composition of the frangible shell, a thickness of the frangible shell, a ratio between the shell thickness or weight to volume or weight of the indicator material, a diameter of the microcapsules, a temperature applied to the shells, etc.

According to some embodiments, the frangible shell is electrically nonconductive, insulative, resistive, or otherwise resists, and may substantially prevent the conduction of electricity through the microcapsule.

### Indicator Materials

According to some embodiments, the microcapsules disclosed herein contain a payload including both a liquefiable material and an accompanying indicator material. When in the solid state, the liquefiable material may substantially prevent movement, migration or diffusion of the indicator material through the liquefiable material. When the liquefiable material is in the liquid state, the indicator material may be able to migrate, move or diffuse through the liquefiable material, and in some embodiments the indicator material is transportable by the liquefiable material.

Generally, an indicator material produces or facilitates the production of a detectable indication, e.g., a change in color state or electrical property, in response to a predetermined environmental stimulus, e.g., heating above a threshold temperature. When combined with a liquefiable material, the indicator material is configured to produce, either alone or in combination with other elements, a detectable indication when the liquefiable material liquefies (e.g., in response to a predetermined environmental exposure).

The simplest form of indicator material may be a colorant, dye, or other material that may be transported by the liquefiable material.

Some embodiments of indicator materials discussed here utilize two or more compounds capable of reacting with each other to yield a color change. In some embodiments, the two or more reactants may be separated within a single microcapsule and prevented from mutual contact by a liquefiable material in a solid state. In some embodiments two or more reactants may be and contained in distinct microcapsules, which substantially prevent the compounds from interacting prior to the rupturing of the microcapsules. Alternatively, a first of the compounds may be contained in the microcapsules, and a second of the compounds may be disposed in an indicator region of the indicator.

Used in combination with the liquefiable material, in some embodiments, are color-reacting materials, such as two reactants kept separate by the microcapsules but allowed to react with each other after rupture or migration. Dyes can also be dissolved in such liquefiable materials to provide an intense color. In some embodiments, the color-reacting materials, or color-forming reactants, produce a distinct color change or change in opacity when brought into contact with each other. A common embodiment is the use of a leuco dye system.

When the reactants come into contact, the appearance change of the indicator may be to go from clear to black, from clear to a dark color, from a light color to a dark color, from a light color to black, etc. In some embodiments, a background is visible through the liquefiable layer(s) prior to the reaction, thereby indicating that the predetermined temperature threshold and required exposure period have not yet been satisfied. The background may include words, numbers, or a pattern, or may simply comprise a color that is easily obscured by the color-forming reaction of the reactants. In some embodiments, a pattern on the background is at least partially obscured by the light color of the liquefiable layer(s), and the pattern becomes more visible after the color-forming reaction. For embodiment, if the pattern is formed with an ink having a color similar to the color of the pre-reacted reactants, a color change produced by the interaction of the color-forming reactants may render the pattern more visible.

In some embodiments, the liquefiable material may also serve as an indicator material. Some liquefiable materials exhibit visibly detectable changes when undergoing a phase change, such as changes in opacity. Some indicators of the present disclosure may rely on such visibly detectable changes of the liquefiable material as the production of the observable effect, and include components configured to visually emphasize the visibly detectable change when the change occurs.

Some embodiments discussed herein utilize conductive particles which, when employed in tandem with a liquefiable material, may be held separately from one another when the liquefiable material is in the solid phase, and be configured to form an electrical connection between two electrodes when the liquefiable material is in the liquid phase. Thus, by measuring the conductivity between the two electrodes, the state of the liquefiable material can be determined, or rather, an exposure of the liquefiable material to the predetermined environmental exposure may be confirmed. According to some embodiments, the conductive particles may include particles of conductive metals, such as copper, silver, gold, aluminum, zinc, tin, similar metals, and alloys thereof. The conductive particles may also include particles of graphene, graphite, electroconductive carbon black, graphene oxides, and other functionalized graphenes, and particles containing conductive non-metals. The conductive particles may be formed in whole or in part by any electrically conductive substance or material operable to be particlized to a sufficient size to fit within the shell of a microcapsule.

Some embodiments of indicator materials discussed herein utilize colored or bright materials, such as dyes, flash materials, and other colorants. In some embodiments, liquefaction of the liquefiable material may result in a change in opacity of the liquefiable material, which may reveal or obscure the indicator material. In some embodiments, the liquefiable material may transport the indicator material from a non-viewable or concealed location to a viewable location when in the liquid state.

### Section II: Rupturable Microcapsules

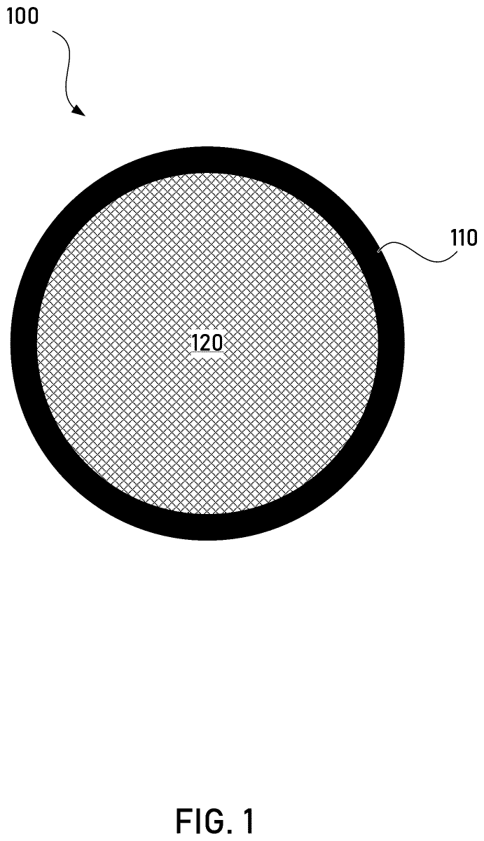

FIG. 1 illustrates a cross-sectional view of a microcapsule 100, as may be used in an activatable indicator, according to embodiments of the present disclosure.

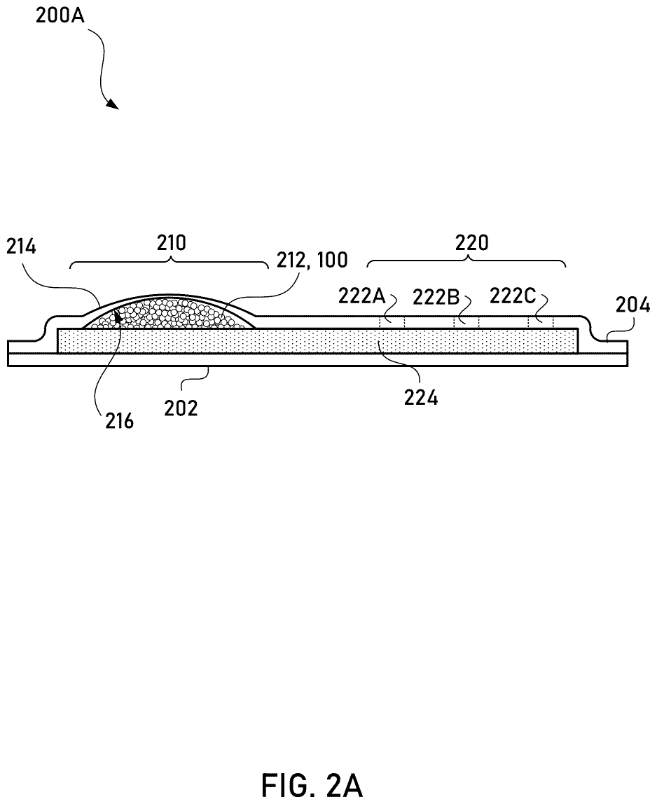

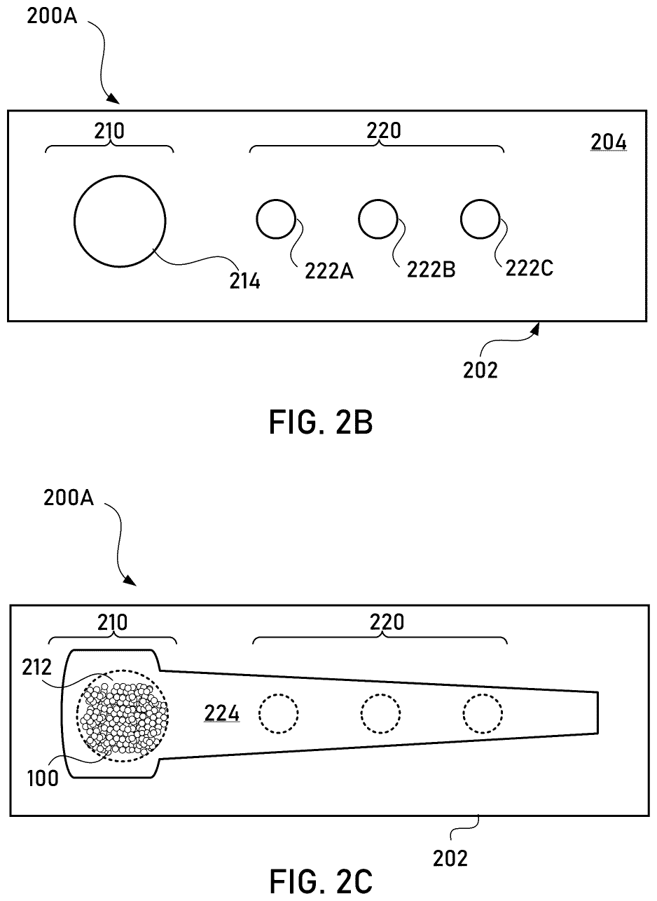

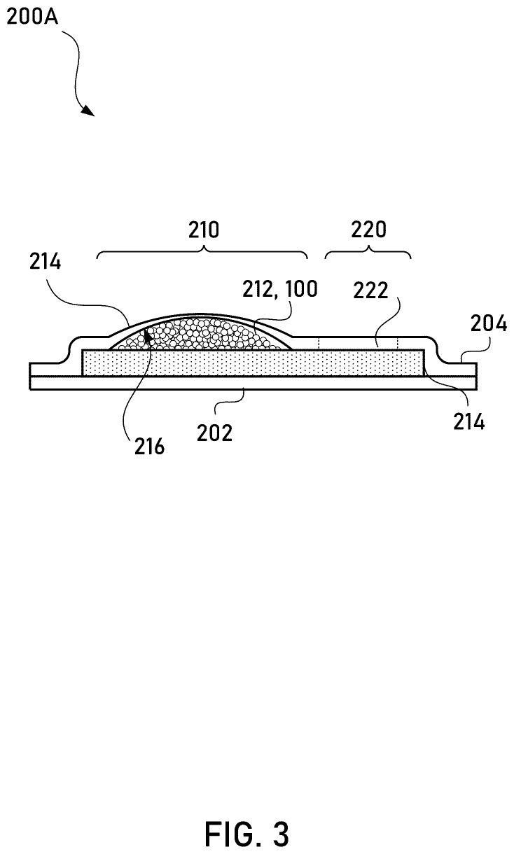

The microcapsule 100A includes a frangible shell 110. The frangible shell 110 contains a payload 120. In some embodiments, the payload 120 includes a liquefiable material combined with an indicator material, which may be configured to produce an effect (e.g., either alone or in tandem with elements of an indicator (see FIGS. 2A-3B)) when the liquefiable material transitions from a solid phase to a liquid phase.

With respect to the payload 120, in some embodiments, the liquefiable material forms a solid matrix when in the solid phase, such that indicator material is embedded within a matrix formed by the liquefiable material. When the liquefiable material liquefies, the liquefiable material may act as a transport material with respect to the indicator material. When liquefiable material liquefies, the indicator material is released from the matrix and movement of the indicator material is facilitated through the liquefied liquefiable material. Furthermore, the when the liquefied liquefiable material is acted upon (e.g., by wicking action, capillary action, gravity or other forces) and compelled to motion, the liquefied liquefiable material may transport the indicator material as the liquefiable material moves.

In the present disclosure, the payload 120 includes a sufficient proportion of the liquefiable material that when the liquefiable material liquefies, the payload 120 as a whole, notwithstanding suspended or contained solids (e.g. indicator materials) being contained therein, substantially acts as a liquid. Thus, throughout the disclosure the payload 120 may be said to liquefy. It is understood that reference to the payload 120 liquefying or being liquefied (e.g., and other variations across parts of speech) indicates only that the liquefiable material within the payload 120 is liquefied. Such language does not imply or indicate that the payload 120 does not contain or include non-liquid materials, nor does such language indicate that any material within the payload 120 apart from the liquefiable material is necessarily liquefied.

According to some embodiments, the liquefiable material of the payload 120 may be one of, or a combination of the liquefiable materials listed above in Section I. Furthermore, the indicator material may be one of, or a combination of, the indicator materials listed above in Section I. Moreover, payload 120 materials (e.g., liquefiable materials and indicator materials) may be selected according to other features or design constraints of the indicators with which the microcapsules 100 are to be employed. Some liquefiable materials may exhibit advantageous properties with some wicks, some indicator materials, some temperature ranges, and so forth.

The microcapsule 100 may be any size, but in one such embodiment, has an outer diameter length between 20 to 1000 micrometers (μm). The frangible shell 110 may be any size smaller than or equal to the outer diameter of the microcapsule 100A. The frangible shell 110 can have a thickness of between 1 to 25 μm. The ratio of the total weight of the contents (e.g. thermally expandable microsphere, payload 120) within the microcapsule 100A to the entire weight of the microcapsule 100A including the contents contained within the microcapsule 100A, can range from 50 percent to 90 percent. A variety of frangible shell 110 materials may be chosen, depending on the application, and the nature of the payload 120 of the microcapsule 100. In general, the frangible shells 110 should resist the passage, whether by flow, diffusion, or migration, of the payload 120 of the microcapsule 100A, prior to activation.

Generally speaking, the microcapsule 100 is configured to be activated responsive to an application of an activation action, or in some embodiments, two activation actions. When activated, the frangible shell 110 of the microcapsule 100A is disengaged, such that the payload 120 of the microcapsule 100 is exposed to the environment. When the payload 120 is exposed to the environment, an exposure to the predetermined environmental exposure causes the payload 120 to transition to the liquid state. In this manner, when the payload 120 is exposed to the environment, the payload 120 is primed to begin sensing, or is environmentally sensitive.

The microcapsule 100 may be “activated” or ruptured by exposing the microcapsule 100 to an activation action (e.g. activation stress, activation exposure, activation event, etc.) exceeding a predetermined activation threshold. The activation action may cause the microcapsule 100 to fracture, melt, break, dissolve, sublime, become porous, or otherwise disengage, allowing the release of the contents of the microcapsule 100.

In some cases, pressure contributes to the activation, e.g., by breaking microcapsules 100, either alone or in combination with elevated temperature. In such embodiments, the activation action is a compressive stress, or a shearing stress, where the predetermined activation threshold is a stress exceeding about 0.1 pounds per square inch (psi), a stress exceeding about 0.5 psi, a stress exceeding about 1 psi, a stress exceeding about 2 psi, a stress exceeding about 5 psi, a stress exceeding about 10 psi, or a stress exceeding about 15 psi.

Generally, prior to activation, the frangible shells 110 are configured to block the payload 120 from flowing, diffusing, or otherwise being released from the microcapsule 100, whether the payload 120 is liquefied or solidified.

### Section III: Embodiments of Activatable Environmental Exposure Indicators

### Activatable Environmental Exposure Indicator: Time-Temperature Indicator

FIGS. 2A-2C illustrate various views of a first embodiment of an activatable environmental exposure indicator 200A (e.g., time-temperature indicator), according to embodiments of the present disclosure. FIG. 2A illustrates a cross-sectional view of the activatable environmental exposure indicator 200A. FIG. 2B illustrates a profile view of the activatable environmental exposure indicator 200A, and FIG. 2C illustrates the profile view of FIG. 2B with certain features hidden or omitted so other features are more easily viewed. The activatable environmental exposure indicator 200 includes a substrate 202, a wick 224, and a plurality of activatable microcapsules 100, each microcapsule 100 including a payload 120 microencapsulated in a frangible shell 110. The plurality of activatable microcapsules 100 is disposed in a reservoir 212 formed by a blister 214 adjacent to the wick 224. As illustrated, the activatable environmental exposure indicator 200 includes a cover layer 204 which overlays the wick 224 and defines viewing windows 222A-C. In some embodiments, the blister 214 is unified with the cover layer 204. For example, the cover layer may be a sheet of transparent plastic which is vacuum molded to produce the blister area.

The activatable environmental exposure indicator 200 defines an activation region 210 and an indicator region 220. The activation region 210 is configured to receive a localized compressive force, (e.g., by a user) which activates the activatable environmental exposure indicator 200 to begin environmental sensing. The indicator region 220 is the region of the activatable environmental exposure indicator 200 in which the payload 120 contained in the microcapsules 100 produces an observable effect after activation of the activatable environmental exposure indicator 200 and responsive to the activatable environmental exposure indicator 200 being exposed to a predetermined exposure.

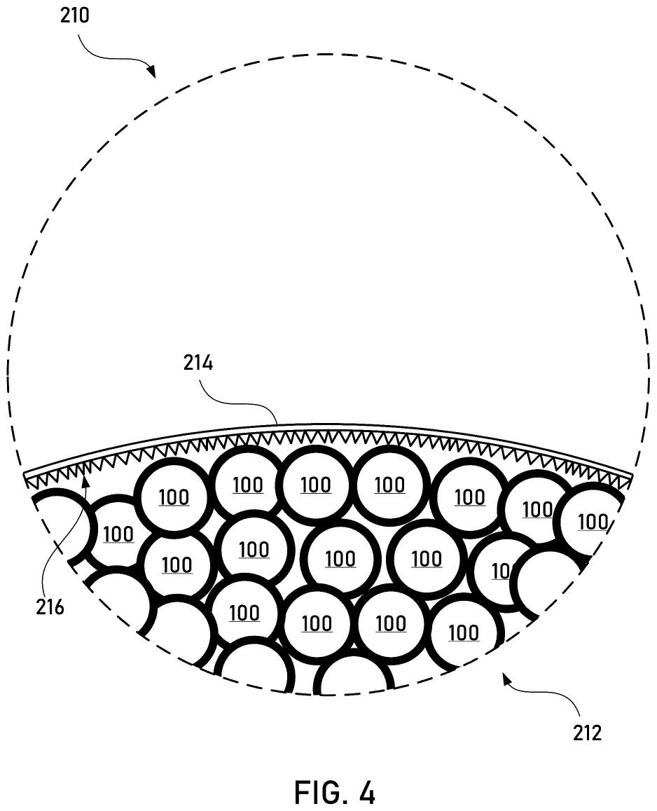

The blister 214 is disposed in the activation region 210, and the blister 214 includes an internal surface 216 which faces the microcapsules 100. Generally, the blister 214 is formed of a deformable material, and structurally forms a reservoir in which the microcapsules 100 are contained. Prior to the application of the localized compressive force, the blister 214 has an initial structure and a corresponding initial volume. When the localized compressive force is applied to the blister 214, the blister 214 deforms, thus decreasing the volume of the reservoir 212 and transferring a compressive stress to the microcapsules 100, crushing the microcapsules 100 between the internal surface 216 and the wick 224. In some examples, the blister is formed of a material including or consisting of polyvinyl chloride (PVC), polyethylene terephthalate (PET), polypropylene, polychlorotrifluoroethylene (PCTFE), linear low-density polyethylene (LLDPE), polyvinylidene chloride (PVDC), cyclic olefin copolymer (COP), and combinations thereof. In some embodiments, the internal surface 216 of the blister is a rough or abrasive surface, which is configured to facilitate the rupturing of the microcapsules 100 when the microcapsules 100 are crushed responsive to the localized compressive force being applied to the blister 214. A detailed view if the internal surface 216 is illustrated in FIG. 4. Generally, the internal surface 216 is configured to have abrasive features either applied or formed on the internal surface 216 which are generally configured to puncture, slice, or otherwise disengage the frangible shells 110 of the microcapsules 100. It is noted that the microcapsules 100 are configured to rupture from compression alone, however the abrasive surface of the internal surface 216 is configured to accelerate the rupturing of the microcapsules 100 as well as increase a proportion of microcapsules 100 which are ruptured responsive to the localized compressive force being applied to the blister 214.

The internal surface 216 may include an applied grit or abrasive media coupled to the internal surface 216. embodiments of abrasive media suitable for use in activatable environmental exposure indicators 200 includes aluminum oxide, crushed or particlized glass, ceramic abrasives, mineral sands/particlized minerals, and cellulose based abrasive media (e.g., crushed walnut shells, corncobs, plant media). In some embodiments, the internal surface 216 may be abraded, roughened, or otherwise processed such that the abrasive surface is formed on the internal surface 216.

In some examples, an additional rough or abrasive surface may be applied or formed on the wick 224, or the substrate 202 contacting the microcapsules 100 in a plane opposed to the internal surface 216 of the blister 214. In such examples, the additional rough or abrasive surface may further aid in rupturing the microcapsules when the activation action is applied to the blister 214.

The microcapsules 100 are configured to rupture when the compressive stress transferred to the microcapsules exceeds an activation pressure threshold. In various embodiments, the activation pressure threshold may be in a range of about 0.1 psi to about 1 psi, about 1 psi to about 5 psi, about 5 psi to about 10 psi, about 10 psi to about 15 psi, or greater than 15 psi. The provided range is purely exemplary, as it is understood that the microcapsules 100 may be configured to rupture responsive to many activation pressure thresholds.

As illustrated, the wick 224 extends between the substrate 102 and the reservoir 212. In some embodiments, the wick 224 may extend along the substrate 202 up to the blister 214, and the microcapsules 100 disposed directly on the substrate 202. Generally, the wick 224 is in fluid communication with the reservoir 212, such that the payload 120, when released from the microcapsules 100 and liquefied, flows into the wick 224.

After being released from the frangible shells 110, and responsive to a predetermined environmental exposure, the payload 120 liquefies and migrates into and along the wick 224. The payload 120 is configured to produce an observable effect in the portions of the wick 224 through which the payload 120 has migrated.

Generally, the activatable environmental exposure indicator 200A is a time-dependent indicator, and the predetermined environmental exposure to which the activatable environmental exposure indicator 200A responds is an environmental exposure exceeding (e.g., positively or negatively) a predetermined exposure threshold, and remaining in excess of the predetermined exposure threshold for at least a predetermined period of time.

In some embodiments, the predetermined environmental exposure may be an ambient temperature excursion above a predetermined temperature threshold for at least a predetermined amount of time, an ambient temperature excursion below a predetermined temperature for at least a predetermined amount of time, cumulative exposure to an ambient temperature over a time period above a predetermined threshold for at least a predetermined amount of time, an exposure to a particular chemical for a predetermined period of time, an oxygen exposure lasting for a predetermined period of time, an ammonia exposure lasting for a predetermined period of time, an exposure to a particular chemical above a threshold concentration for at least a predetermined period of time, an exposure to a particular chemical above the threshold concentration for at least a predetermined amount of time, an exposure to at least a predetermined amount of radiation of a particular type for at least a predetermined amount of time, a predetermined electromagnetic exposure for at least a predetermined amount of time, and an exposure to a humidity level above a predetermined threshold for at least a predetermined amount of time.

In some embodiments, after the application of the activation action, (e.g., after the frangible shells 110 of the plurality of microcapsules 100 are ruptured and the payload 120 is released therefrom), and responsive to the predetermined environmental exposure, the payload 120 liquefies and migrates into the wick 224. As the activatable environmental exposure indicator 200A is configured to indicate an amount of time for which the activatable environmental exposure indicator 200A is exposed to an environmental condition exceeding a predetermined threshold.

The liquefied payload 120 migrates through the wick 224 at a substantially predetermined rate, such that a distance through the migration region that the liquefied payload 120 has migrated corresponds to an amount of time for which the activatable environmental exposure indicator 200A has been exposed to the environmental condition exceeding the predetermined threshold. The payload 120 and the wick 224 may be configured to indicate any amount of time that the activatable environmental exposure indicator 200A is exposed to the environmental condition exceeding the predetermined threshold, but as non-limiting embodiments, the activatable environmental exposure indicator 200A may be configured to indicate cumulative exposure durations of about 10 minutes, about 30 minutes, about 1 hour, about 3 hours, about 10 hours, or of about 24 hours.

The liquefiable material of the payload 120 may also be configured to solidify and halt migration of the payload 120 when the environmental condition no longer exceeds the predetermined threshold (e.g., recedes below the predetermined threshold). In this manner, the payload 120 is only liquefied and migrates through the migration region when the environmental condition exceeds the predetermined threshold and is solidified and does not migrate through the migration region when the environmental condition does not exceed the predetermined threshold. The payload 120 may be configured to solidify responsive to the environmental condition receding below the predetermined threshold.

In some embodiments, the migration region may be configured as the indicator region 220. As the payload 120 migrates through the wick 224, the payload 120 may cause the production of the observable effect in the portions of the wick 224 through which the payload 120 has migrated, and the portions of the wick 224 which the payload 120 has not migrated through remain in an initial state, where the observable effect has not (e.g., not yet) been produced.

In other embodiments, the indicator region 220 may be a feature or component located at the end of the wick 224, such that the payload 120 migrates along the wick 224, and after a predetermined period of time for which the activatable environmental exposure indicator 200A has been exposed to the environmental condition in excess of the predetermined threshold, the payload 120 reaches a destination feature, such as a demarcated portion of the wick 224 or a destination reservoir.

The viewing windows 222A-C are defined in the indicator region 220, such that a user may view portions of the wick 224 in which the payload 120 is configured to produce the observable effect to determine if the observable effect has been produced, and thus determined if the activatable environmental exposure indicator has been exposed to the predetermined environmental exposure. Additionally, in embodiments where the indicator region 220 includes a destination feature, the destination feature may be aligned with a respective viewing window 222.

The activatable environmental exposure indicator 200A may include various indices which correspond to different amounts of time that the activatable environmental exposure indicator 200A has been exposed to the environmental condition exceeding the predetermined threshold. In some embodiments, the viewing windows 222 are configured as a single window through which the migration region is viewable, and the cover layer includes printed indicia corresponding to indices within the migration region such that a the distance along the wick 244 that the payload has travelled is correlated to a specific interval of time which the activatable environmental exposure indicator 200A has been exposed to the environmental condition exceeding the predetermined threshold. In some embodiments, the viewing windows 222 includes several viewing windows 222A-C, each viewing window 222 disposed at a predetermined location relative to the wick 224 and the migration region, such that when the observable effect is viewable through a given viewing window 222, a user may determine that the activatable environmental exposure indicator 200 has been exposed to the environmental condition exceeding the predetermined threshold for at least the predetermined amount of time which corresponds to the given viewing window 222.

In some embodiments, the cover layer 204 is formed of a transparent material, and the indicator region 220 is viewable to a user through the cover layer 204. FIG. 2C illustrates the activatable environmental exposure indicator 200A with the cover layer 204 hidden, such that FIG. 2C resembles an indicator with a transparent cover layer 204. In this manner, the totality (e.g., or substantial majority) of the indicator region 220 (e.g., wick 224) is viewable to the user, and viewing windows 222 may be omitted. In some such embodiments, the blister 214 is also formed of a transparent material, such that the blister 214 serves as an activation indicator, where the microcapsules 100 are viewable to a user through the blister 214, and thus whether the microcapsules 100 have been effectively ruptured by the activation action (e.g., the localized compressive force) is also viewable to the user. In some such embodiments, the blister and the cover layer 204 may be formed by vacuum molding a transparent layer to the activatable environmental exposure indicator 200A.

In some embodiments, the blister 214 may be integrated with the substrate 102 as opposed to the cover layer 204. In such embodiments, the indicator region 220 may be viewable to a user though the cover layer 204 (via viewing windows 222 or otherwise), or through the substrate 202.

The substrate 202 may be, for example, paper such as a cellulose paper, a natural or synthetic polymer, or other materials. In some examples, the substrate 202 may provide a surface upon which indicia can be printed. In some examples, the substrate 202 may have a thickness in a range of about 10 mm to about 20 mm, from about 1 mm to about 10 mm or from about 10 mm to about 20 mm. As a non-limiting example, the substrate 202 may be one of a Polyolefin, polyamide, polypropylene, polyester Polyimide, Polyart synthetic paper, nylon, or PPG Teslin paper. In some examples, the substrate 202 may be formed of the same material as the cover layer 204, including one or more of polyvinyl chloride (PVC), polyethylene terephthalate (PET), polypropylene, polychlorotrifluoroethylene (PCTFE), linear low-density polyethylene (LLDPE), polyvinylidene chloride (PVDC), and cyclic olefin copolymer (COP). In an example, there may be a topcoat applied to the substrate 202. Optionally, the substrate 202 may further include a release liner and/or an adhesive backing to allow the substrate 202 to be selectively attached to surfaces, e.g., as a label.

In the illustrated embodiment of FIGS. 2A-2C, the indicator region 220 includes a wick 224. In various embodiments the indicator region 220 may include other components or take other forms. In some embodiments the indicator region 220 and the migration region may include microchannels or capillary tubes configured to support migration of the liquefied payload 120.

The payload 120 is configured to produce an observable effect upon reaching the indicator region 242. In some embodiments, the indicator material of the payload 120 is a dye, ink, or other colorant, and the wick 224 appears to change from an initial color state to a second color state as the wick 224 is saturated by the payload 120. In various embodiments the indicator material contained in the payload 120 may change an apparent color state of the indicator region 220 by commuting a colorant, which is visibly distinct from an initial color of the indicator region 220, to the indicator region 220. In some embodiments, the indicator material may be a flash material or a reflective material, which is configured to give off a bright appearance when illuminated with light of a particular wavelength.

In some embodiments, the indicator material is a two-component dye or ink (e.g., dye-forming combination), which produces a change in apparent color state upon mixing two reactants together. In some embodiments, a first reactant (e.g., a color former) and a second reactant (e.g., a color developer) are separately held in separate microcapsules 100 in which the first reactant is suspended or embedded in a matrix formed by the liquefiable material in a solid state in a first subset of the microcapsules 100 and the second reactant is suspended or embedded in a solid matrix formed by the liquefiable material in a second subset of the microcapsules 100. Upon release from the microcapsules 100, and the liquefaction of the liquefiable material, the first and second reactants are released from the respective solid matrices and subsequently mixed, producing the color change which is transferred to the indicator region 220 as the liquefied payload 120 migrates thereto.

In other embodiments, the first reactant is contained in the microcapsules 100 and the second reactant is disposed in the indicator region 220, such that when the liquefied payload 120 reaches the indicator region 220 the first and second reactants are mixed, and the color change is produced in the indicator region 220.

In some embodiments, the indicator material in the payload 120 may be a conductive material, such that the observable effect is a change in an electrical property of the indicator region 22, such as conductivity, resistivity, impedance, capacitance, and inductance. In such embodiments, the indicator region may include a wire or trace, which is monitored by a connected circuit, and the observable effect is observed by the circuit when the electrical property of the indicator region 220 changes.

In some examples, the activation region 210 and the indicator region 220 may be disposed on opposite faces of the activatable environmental exposure indicator 200A. Said differently, the activatable environmental exposure indicator 200A may be configured such that that the indicator region is viewable when viewing the substrate 202 face, and the activation region 210 is viewable when viewing the cover layer 204 face, or vice versa. In this manner, the blister 214 may not interfere with viewing the totality of the wick 224.

### Activatable Environmental Exposure Indicator: High Temperature Excursion Indicator

FIG. 3 illustrates a second embodiment of an activatable environmental exposure indicator 200B (e.g., high-temperature excursion indicator), according to embodiments of the present disclosure. The activatable environmental exposure indicator 200B includes a substrate 202, a wick 224, and a plurality of activatable microcapsules 100, each microcapsule 100 including a payload 120 microencapsulated in a frangible shell 110. The plurality of activatable microcapsules 100 is disposed adjacent to the wick 224, and generally contained in a reservoir 212 formed by a blister 214. Several features are shared between the first embodiment of the activatable environmental exposure indicator 200A and the second embodiment of the activatable environmental exposure indicator 200B, and except where noted and otherwise described, the discussion of the features of first embodiment of the activatable environmental exposure indicator 200A applies to the second embodiment of the activatable environmental exposure indicator 200B.

Generally, the activatable environmental exposure indicator 200 defines an activation region 210 and an indicator region 220. In some examples the indicator region 220 and the activation region 210 jointly occupy a shared space. The activatable environmental exposure indicator 200B is configured to indicate a single occurrence of an environmental condition exceeding a predetermined threshold. As such, the payload 120 of the microcapsules 100 preferably has a sharp melting point, where the liquefiable material in the payload 120 liquefies over a small temperature range, e.g., less than 2 degrees C., and has a relatively low viscosity once liquefied, such that the payload 120 rapidly migrates to the indicator region 220 after being released from the frangible shells 110 and liquefied responsive to the environmental condition exceeding the predetermined threshold. In some examples, the payload 120 has a viscosity between 1 and 200 centipoise (cP) when liquefied.

In examples where the indicator region 220 and the activation region 210 occupy a shared space, the viewing window 222 may be omitted in favor of a transparent blister 214 and cover layer 204, where the observable effect is produced in and is viewable in the same region that the localized compressive force is applied. In this case, if abrasive materials are added to the blister, they may be transparent or translucent materials or added in a sufficiently low quantity that they do not interfere with viewing the indicator.

### Indicator Bulk Supply

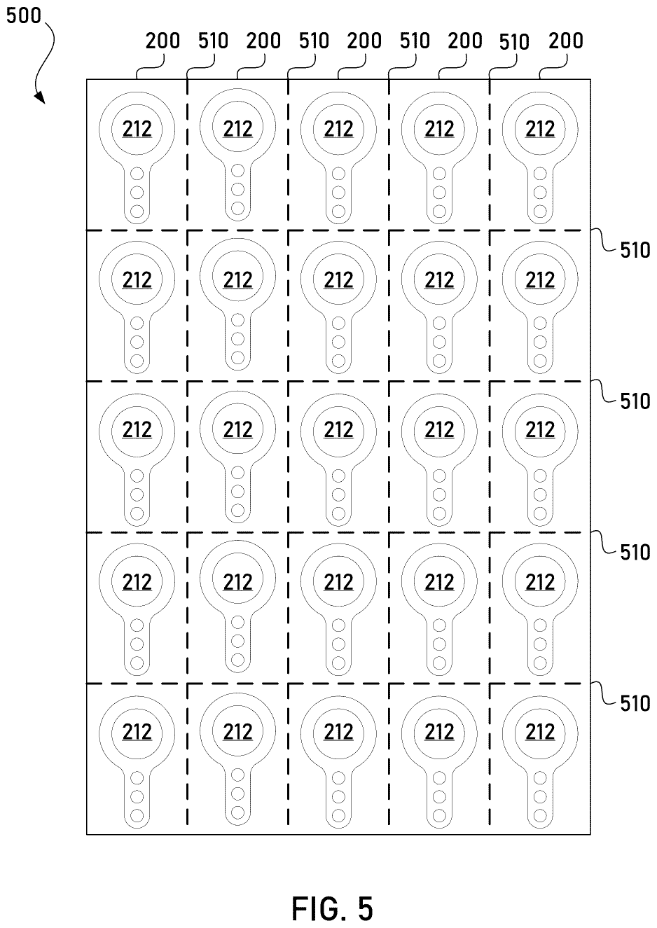

FIG. 5 illustrates an article of manufacture, configured as a web 500 of activatable environmental exposure indicators 200. In the illustrated embodiment, the activatable environmental exposure indicators 200 in the web 500 are time-dependent exposure indicators (e.g., activatable environmental exposure indicator 200A) however excursion exposure indicators (e.g., activatable environmental exposure indicator 200B) are also contemplated. The web 500 may serve as a transportation, storage, or bulk supply configuration. As activatable environmental exposure indicators 200 are generally consumable items, such bulk supplies (e.g., web 500) may serve as an advantageous product format for distribution.

Each activatable environmental exposure indicator 200 in the web may be demarcated from another activatable environmental exposure indicator 200 in the web by a line of weakness 510. Although illustrated as an array having five rows and five columns of activatable environmental exposure indicators 200, the web of activatable environmental exposure indicators 200 may include any number of rows and columns of activatable environmental exposure indicators 200. In various embodiments, the lines of weakness may be scores, folds, perforated lines, or cuts, such that the activatable environmental exposure indicators 200 are uniformly separable from one another when torn or cut along the lines of weakness 510.

In some embodiments, the web 500 supports bulk activation, and the web 500 may be passed under a roller or a press which depresses each blister 214, activating each activatable environmental exposure indicator 200.

In some embodiments, the web 500 may be configured as a roll and wound about a spool.

### Methods of Forming Activatable Environmental Exposure Indicators

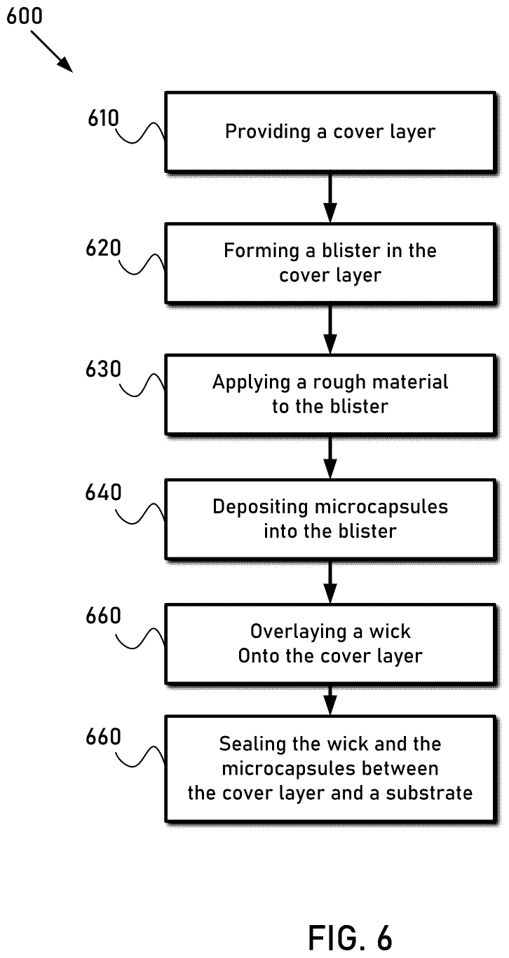

FIG. 6 illustrates a flowchart of a method 600 for forming an activatable environmental exposure indicator (e.g., activatable environmental exposure indicator 200A, activatable environmental exposure indicator 200B), according to embodiments of the present disclosure. The method 600 may be deployed to form a single activatable environmental exposure indicator or be applied to form a web of activatable environmental exposure indicators (e.g., web 400).

Block 610 describes a step of the method 600, in which a cover layer is provided, according to embodiments of the present disclosure. The cover layer (e.g., cover layer 204) may be a sheet or other article of media or material which is suitable to serve as the cover layer of one or more activatable environmental exposure indicators. Some such materials include a Polyolefin, polyamide, polypropylene, polyester Polyimide, Polyart synthetic paper, nylon, PPG Teslin paper, polyurethane tetrachloride, polyvinyl acetate, or other plastic, and combinations thereof.

Block 620 describes a step of the method 600, in which blister (e.g., blister 214) is formed in the cover layer, according to embodiments of the present disclosure. In examples where multiple activatable environmental exposure indicators are being produced, many blisters are formed. In some embodiments, a portion of the cover layer is deformed to form the blister (e.g., via pressure, either with or without the application of heat). In some examples, a separate blister component is installed in, or otherwise operatively coupled to the cover layer.

In some embodiments, other features may be imparted to the cover layer at block 620. In examples where a web of activatable environmental exposure indicators is being produced, lines of weakness (e.g., lines of weakness 410) are imparted to the cover layer. In some embodiments, viewing windows (e.g., viewing windows 222) are formed in the cover layer, (e.g., via stamping, cutting or other conventional method of forming).

Block 630 describes a step of the method 600, in which rough material is applied to the blister, according to embodiments of the present disclosure. In some embodiments, an abrasive media (e.g., aluminum oxide, crushed or particlized glass, ceramic abrasives, mineral sands/particlized minerals, or cellulose based abrasive media) is deposited in the blister(s) and may be coupled to the blister(s) by an adhesive to form a rough surface (e.g., internal surface 216) on the blister. In other embodiments, the internal surface of the blister may be processed by a tool or other implement, such that the internal surface of the blister is processed to become a rough or abrasive surface.

Block 640 describes a step of the method 600 in which microcapsules are deposited into the blisters, according to embodiments of the present disclosure. The microcapsules (e.g., microcapsule 100) contain a payload (e.g., payload 120) encapsulated in a frangible shell (e.g., frangible shell 110). The frangible shell is configured to rupture responsive to the application of an activation action, releasing the payload. The payload is configured to liquefy responsive to a predetermined environmental exposure. The frangible shell is configured to retain the payload prior to rupture, and the payload is free to flow when liquefied after rupture of the frangible shells by the activation action.

In some embodiments the microcapsules may be dispensed into the blisters in a dry particle form. In some embodiments the microcapsules may be dispensed into the blisters suspended in a liquid or gel medium.

Block 650 describes a step of the method 600 in which a wick (e.g., wick 224) is overlayed on the cover layer, according to embodiments of the present disclosure. In some embodiments, the wick includes an activation portion, which is configured such that a portion of the wick overlays, is adjacent to, or otherwise contacts the blister and the microcapsules. In some embodiments, the wick includes an indicator portion. In some embodiments the wick includes a migration portion.

Block 660 describes a step of the method 600 in which a substrate is overlayed onto the cover layer, according to embodiments of the present disclosure. In some embodiments, the substrate (e.g., substrate 202) is overlayed such that the wick and microcapsules are sandwiched between the cover layer and the substrate. The substrate may be a sheet or other article of media or material which is suitable to serve as the substrate of one or more activatable environmental exposure indicators. Some such materials include a Polyolefin, polyamide, polypropylene, polyester Polyimide, Polyart synthetic paper, nylon, and PPG Teslin paper.

Block 670 describes a step of the method 600 in which the wick and microcapsules are sealed between the cover layer and the substrate, according to embodiments of the present disclosure. In some examples the substrate and the cover later may be vacuum molded together. In some examples the cover layer and the substrate may heat welded together. In some examples the substrate and the cover layer may be adhered to one another by an adhesive. In this manner, one or more activatable environmental exposure indicators may be formed.

In some examples in which a web of activatable environmental exposure indicators is being formed, lines of weakness may be imparted between the activatable environmental exposure indicators (e.g., into both the substrate and the cover layer), such that a web of activatable environmental exposure indicators is formed.

After the steps described by block 660, the method 600 may be concluded. Certain steps of the method 600 may be omitted, other steps may be included, and steps may be performed in an order other than the order described above without departing from the scope of the present disclosure.

In the foregoing specification, specific embodiments have been described. However, one of ordinary skill in the art appreciates that various modifications and changes can be made without departing from the scope of the technology as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed technology is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An activatable environmental exposure indicator, comprising:
a substrate;
an indicator region;
a reservoir in fluid communication with the indicator region;
a blister covering the reservoir and having an internal surface; and
a plurality of microcapsules, contained in the reservoir and covered by the blister;
wherein each microcapsule of the plurality of microcapsules comprises a payload microencapsulated in a frangible shell,
wherein the payload comprises a liquefiable material configured to liquefy responsive to a predetermined environmental exposure,
wherein the frangible shells are configured to rupture responsive to an activation action, releasing the payload from the frangible shells, and
wherein, after being released from the frangible shells, and responsive to the predetermined environmental exposure causing the liquefiable material to liquefy, the payload is configured to migrate into the indicator region producing an observable effect in the indicator region,
wherein the frangible shells are configured to block the payload from migrating to the indicator region prior to the activation action,
wherein applying a compressive force exceeding a predetermined threshold to the blister causes the blister to deform so the internal surface of the blister contacts the plurality of microcapsules, so that the activation action is applied to the plurality of microcapsules.

2. The activatable environmental exposure indicator of claim 1, wherein the internal surface of the blister includes a rough material, configured to facilitate rupturing the frangible shells when the blister applies the activation action to the plurality of microcapsules.

3. The activatable environmental exposure indicator of claim 2, wherein a surface of the reservoir opposite the internal surface of the blister includes a rough material, configured to facilitate rupturing the frangible shells when the blister applies the activation action to the plurality of microcapsules.

4. The activatable environmental exposure indicator of claim 1, wherein the reservoir is housed within the indicator region, and the blister comprises a transparent material wherein the observable effect is viewable through the blister when the payload produces the observable effect in the indicator region.

5. The activatable environmental exposure indicator of claim 1, wherein the blister is integrated with a cover layer which overlays the activatable environmental exposure indicator.

6. The activatable environmental exposure indicator of claim 5, wherein the cover layer further comprises at least a viewing window through which the indicator region is viewable.

7. The activatable environmental exposure indicator of claim 5, wherein the cover layer is a vacuum molded transparent layer.

8. The activatable environmental exposure indicator of claim 1, wherein the blister is integrated with the substrate.

9. The activatable environmental exposure indicator of claim 1, wherein the blister comprises a material selected from the group consisting of polyvinyl chloride (PVC), polyethylene terephthalate (PET), polypropylene, polychlorotrifluoroethylene (PCTFE), linear low-density polyethylene (LLDPE), polyvinylidene chloride (PVDC), cyclic olefin copolymer (COP), and combinations thereof.

10. The activatable environmental exposure indicator of claim 1, wherein the indicator region is selected from a group consisting of a destination wick which is configured to be saturated by the payload when liquefiable material is liquefied, and a destination reservoir into which the payload is configured to flow when the liquefiable material is liquefied.

11. The activatable environmental exposure indicator of claim 1, further comprising a migration component, connectively disposed between the indicator region and the reservoir, wherein the payload migrates through the migration component when the liquefiable material is liquefied and after the activation action.

12. The activatable environmental exposure indicator of claim 11, wherein the predetermined environmental exposure is an exposure to an environmental condition above a predetermined threshold, and liquefiable material is configured to liquefy responsive to the environmental condition exceeding the predetermined threshold and solidify responsive to the environmental condition receding below the predetermined threshold,
wherein, after of the activation action, the payload migrates through the migration component while the environmental condition exceeds the predetermined threshold, and halts migration when the environmental condition recedes below the predetermined threshold and until the environmental condition subsequently exceeds the predetermined threshold.

13. The activatable environmental exposure indicator of claim 12,
wherein the activatable environmental exposure indicator is a time-temperature indicator, configured such that the environmental condition is an ambient temperature, and the predetermined threshold is a temperature threshold,
wherein, after the payload is released form the frangible shells, responsive to the activatable environmental exposure indicator being exposed to a temperature above the predetermined threshold the payload migrates along the migration component, and the liquefiable material solidifies at a temperature below the predetermined threshold, halting migration of the payload along the migration component.

14. The activatable environmental exposure indicator of claim 12, further comprising a plurality of indicator regions, each of the plurality of indicator regions disposed at a respective predetermined location along the migration component, wherein after the activation action, the payload is configured to reach each predetermined location after a respective amount of time for which the environmental condition exceeds the predetermined threshold, and produce the observable effect in corresponding respective indicator region.

15. The activatable environmental exposure indicator of claim 11, wherein the migration component is selected from a group consisting of a wick, a plurality of capillary tubes, a plurality of microchannels.

16. The activatable environmental exposure indicator of claim 1, wherein the observable effect is a change in an apparent color state of at least a portion of the indicator region resulting from the payload reaching the portion of the indicator region and the payload includes an indicator material configured to change the apparent color state of the portion of the indicator region, the indicator material having a component selected from a group consisting of: a dye, a colorant, an ink, a first reactant configured to react with a second reactant disposed in the indicator region to produce a color state change, a reflective material, a flash material configured to give a bright appearance when illuminated with light of a predetermined wavelength, and combinations thereof.

17. The activatable environmental exposure indicator of claim 1, wherein the observable effect is a change in an electrical property of the indicator region as detected by a circuit connected to the indicator region, wherein the electrical property is selected from a group consisting of conductivity, resistivity, impedance, capacitance, and inductance.

18. The activatable environmental exposure indicator of claim 17, wherein the payload includes a plurality of conductive particles configured to change the electrical property of the indicator region, the plurality of conductive particles selected from a group consisting of particles containing copper, particles containing silver, particles containing graphite, particles containing graphene, particles containing graphene oxide, particles containing other functionalized graphenes, particles containing conductive metals, particles containing conductive non-metal materials, electroconductive carbon black, and combinations thereof.

19. The activatable environmental exposure indicator of claim 1, wherein the activation action includes a compression force applied to the blister above a predetermined activation pressure threshold selected from a group consisting of: a compression stress exceeding 0.1 pounds per square inch (psi), a compression stress exceeding 0.5 psi, a compression stress exceeding 1 psi, a compression stress exceeding 2 psi, a compression stress exceeding 5 psi, a compression stress exceeding 10 psi, and a compression stress exceeding 15 psi.

20. The activatable environmental exposure indicator of claim 1 wherein the predetermined environmental exposure is selected from a group consisting of: a temperature excursion above a predetermined temperature threshold for at least a predetermined amount of time, temperature excursion below a predetermined temperature for at least a predetermined amount of time, cumulative exposure to temperature for at least a predetermined amount of time above a predetermined threshold, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, a predetermined electromagnetic exposure, a humidity exposure, an exposure to a humidity level above a predetermined threshold, and an exposure to a humidity level above a predetermined threshold for at least a predetermined amount of time.

21. A method of forming an activatable environmental exposure indicator, comprising;
providing a cover layer;
forming a blister in the cover layer;
depositing a plurality of microcapsules into the blister, each microcapsule of the plurality of microcapsules containing a payload microencapsulated in a frangible shell, the frangible shells configured to rupture responsive to an activation action and release the payload, the payload comprising a liquefiable material configured to liquefy responsive to a predetermined environmental exposure, the liquefiable material being retained by the frangible shells prior to rupture, and free to flow when liquefied after rupture of the frangible shells by the activation action;
overlaying a wick onto the cover layer, the wick comprising an activation portion, a migration portion and an indicator portion, the wick adjacent to or in contact with the blister;
overlaying a substrate onto the wick, microcapsules, and cover layer; and
sealing the wick and the plurality of microcapsules between the cover layer and the substrate.

22. The method of claim 21, further comprising applying a rough material to the cover layer at a location of the blister.

23. An article of manufacture comprising:
a web of environmental exposure indicators, each indicator in the web of indicators demarcated by lines of weakness, each indicator in the web of substrates comprising:
a substrate;
an indicator region;
a reservoir in fluid communication with the indicator region;
a blister covering the reservoir and having an internal surface; and
a plurality of microcapsules, contained in the reservoir and covered by the blister;
wherein each microcapsule of the plurality of microcapsules comprises a payload microencapsulated in a frangible shell,
wherein the payload comprises a liquefiable material configured to liquefy responsive to a predetermined environmental exposure,
wherein the frangible shells are configured to rupture responsive to an activation action, releasing the payload from the frangible shells,
wherein, after being released from the frangible shells, and responsive to the predetermined environmental exposure causing the liquefiable material to liquefy, the payload is configured to migrate into the indicator region producing an observable effect in the indicator region, and
wherein the frangible shells are configured to block the payload from migrating to the indicator region prior to the activation action, wherein applying a compressive force exceeding a predetermined threshold to the blister causes the blister to deform so the internal surface of the blister contacts the plurality of microcapsules, so that the activation action is applied to the plurality of microcapsules.
